(19) United States
(12) Patent Application Publication
(10) Pub. No.: US 2021/0319425 A1
(43) Pub. Date: Oct. 14, 2021

(54) PAYMENT APPARATUS, AND NON-TRANSITORY STORAGE MEDIUM

(71) Applicant: NEC Corporation, Minato-ku, Tokyo (JP)

(72) Inventors: Shoko KAWAGUCHI, Tokyo (JP); Naoya YOSHIKAWA, Tokyo (JP)

(73) Assignee: NEC Corporation, Minato-ku, Tokyo (JP)

(21) Appl. No.: 17/265,342

(22) PCT Filed: Apr. 5, 2019
(86) PCT No.: PCT/JP2019/015197

§ 371 Date: Feb. 2, 2021

(30) Foreign Application Priority Data
Aug. 7, 2018 (JP) 2018-148746

(51) Int. Cl. G06Q 20/32; G06Q 20/40; G06Q 20/20; G06Q 20/02

(52) U.S. Cl. CPC G06Q 20/3223; G06Q 20/3221; G06Q 20/3274; G06Q 20/02; G06Q 20/4037; G06Q 20/204; G06Q 20/208; G06Q 20/40145

(57) ABSTRACT

A payment apparatus (20) of the present invention includes a card-related information acquisition unit (21) which acquires card-related information including an available amount of a credit card by reading a code indicating the card-related information or by performing a short-range wireless communication with a mobile terminal in which the card-related information is stored, a product information acquisition unit (22) which acquires product identification information of one or a plurality of products to be paid for, a determination unit (23) which determines whether or not settlement by a credit card is possible based on the available amount and a payment amount calculated based on the product identification information, an output unit (26) which outputs a determination result of the determination unit (23), and a payment unit (24) which performs a payment process based on the determination result of the determination unit (23).

### TECHNICAL FIELD

The present invention relates to a mobile terminal, a relay apparatus, a payment apparatus, a payment system, a method of controlling the mobile terminal, a payment method, a relay method, and a program.

### BACKGROUND ART

Patent Document 1 discloses a method of reducing a settlement time in making settlement using a credit card. In this method, a user operates a mobile terminal to transmit a credit inquiry request to a management computer of a financial payment institution before a payment process. When determining that credit is possible, the management computer transmits a reply of credit data to the mobile terminal. There is no specific description as to what kind of information the credit data is, but it is presumed to be information indicating that the credit is possible, for example, an approval number.

Then, at the time of payment, the user operates the mobile terminal to transmit credit data to an installed terminal device such as a cash register through communication using communication media such as radio waves, electromagnetic waves, and light. Thereafter, the installed terminal device transmits the credit data and cash register data to the management computer. Then, the management computer makes settlement by a credit card based on the received information.

### RELATED DOCUMENT

### Patent Document

[Patent Document 1] Japanese Patent Application Publication No. H11-203358

### SUMMARY OF THE INVENTION

### Technical Problem

In a case where settlement by a credit card is made, it is necessary to determine whether or not a payment amount is less than or equal to an available amount of a credit card. The available amount is a value obtained by subtracting an amount used up to that point within a predetermined period (one month) set for a user of the card from an upper usage limit of the credit card within the predetermined period. In a case where the payment amount is less than or equal to the available amount, settlement by a credit card is possible, and in a case where the payment amount is not less than or equal to the available amount, the settlement by the credit card is not possible. Patent Document 1 does not disclose which entity determines at what timing whether or not the payment amount is less than or equal to the available amount.

Generally, a payment amount and credit card information (card number, expiration date, name, authentication code, and so on) are transmitted from a payment apparatus to a server of a credit card company, and the server determines whether or not the payment amount is less than or equal to an available amount of a user of the card. In a case of such a process, a waiting time of a customer when paying with a credit card can increase due to transmission and reception of information performed between a payment apparatus and a server of a credit card company, a decision process performed by the server, and so on. A problem is remarkable in particular in a country or a region where performance of a communication network is low and time required for communication is long.

An object of the present invention is to reduce a waiting time of a customer when paying with a credit card.

### Solution to Problem

According to the present invention, there is provided a program causing a computer of a mobile terminal to function as an inquiry unit which transmits an inquiry on availability of a credit card to a relay apparatus and receives a response to the inquiry from the relay apparatus; and an output unit which outputs card-related information including an available amount included in the response in a case where content of the response indicates the credit card being available.

Further, according to the present invention, there is provided a mobile terminal including an inquiry unit which transmits an inquiry on availability of a credit card to a relay apparatus and receives a response to the inquiry from the relay apparatus; and an output unit which outputs card-related information including an available amount included in the response in a case where content of the response indicates the credit card being available.

Further, according to the present invention, there is provided a method of controlling a mobile terminal by a computer including

an inquiry step of transmitting an inquiry on availability of a credit card to a relay apparatus and receiving a response to the inquiry from the relay apparatus; and an output step of outputting card-related information including an available amount included in the response in a case where content of the response indicates the credit card being available.

Further, according to the present invention, there is provided a payment apparatus including a card-related information acquisition unit which acquires card-related information by reading a code indicating the card-related information including an available amount of a credit card or by performing a short-range wireless communication with a mobile terminal in which the card-related information is stored, a product information acquisition unit which acquires product identification information of one or a plurality of products to be paid for, a determination unit which determines whether or not settlement by the credit card is possible based on the available amount and a payment amount calculated based on the product identification information, an output unit which outputs a determination result of the determination unit, and a payment unit which performs a payment process based on the determination result of the determination unit.

Further, according to the present invention, there is provided a payment method performed by a computer including a card-related information acquisition step of acquiring card-related information by reading a code indicating the card-related information including an available amount of a credit card or by performing a short-range wireless communication with a mobile terminal in which the card-related information is stored, a product information acquisition step of acquiring product identification information of one or a plurality of products to be paid for, a determination step of determining whether or not settlement by the credit card is possible based on the available amount and a payment amount calculated based on the product identification information, an output step of outputting a determination result of the determination step, and a payment step of performing a payment process based on the determination result of the determination step.

Further, according to the present invention, there is provided a program causing a computer to function as a card-related information acquisition unit which acquires card-related information by reading a code indicating the card-related information including an available amount of a credit card or by performing a short-range wireless communication with a mobile terminal in which the card-related information is stored, a product information acquisition unit which acquires product identification information of one or a plurality of products to be paid for, a determination unit which determines whether or not settlement by the credit card is possible based on the available amount and a payment amount calculated based on the product identification information, an output unit which outputs a determination result of the determination unit, and a payment unit which performs a payment process based on the determination result of the determination unit.

Further, according to the present invention, there is provided a relay apparatus including a relay unit which transmits an inquiry on availability of a credit card to a server of a credit card company when receiving the inquiry on the availability of the credit card from a mobile terminal, and transmits a response to the inquiry to the mobile terminal when the response is received from the server.

Further, according to the present invention, there is provided a relay method performed by a computer, including a relay step of transmitting an inquiry on availability of a credit card to a server of a credit card company when receiving the inquiry on the availability of the credit card from a mobile terminal, and transmitting a response to the inquiry to the mobile terminal when the response is received from the server.

Further, according to the present invention, there is provided a program causing a computer to function as a relay unit which transmits an inquiry on availability of a credit card to a server of a credit card company when receiving the inquiry on the availability of the credit card from a mobile terminal, and transmits a response to the inquiry to the mobile terminal when the response is received from the server.

Further, according to the present invention, there is provided a payment system including the payment apparatus and the relay apparatus.

### Advantageous Effects of Invention

According to the present invention, it is possible to reduce a waiting time of a customer when paying with a credit card.

### BRIEF DESCRIPTION OF THE DRAWINGS

The above-described object, other objects, features, and advantages will be further clarified by the preferred example embodiments described below and the accompanying drawings.

FIG. 1 is a diagram showing an overview of a payment system according to the present example embodiment.

FIG. 2 is a diagram showing an example of a functional block diagram of a mobile terminal according to the present example embodiment.

FIG. 3 is a diagram showing an example of a functional block diagram of a relay apparatus according to the present example embodiment.

FIG. 4 is a diagram showing an example of a functional block diagram of a server according to the present example embodiment.

FIG. 5 is a diagram showing an example of a functional block diagram of a payment apparatus according to the present example embodiment.

FIG. 6 is a sequence diagram showing an example of a process flow of the payment system according to the present example embodiment.

FIG. 7 is a sequence diagram showing an example of a process flow of the payment system according to the present example embodiment.

FIG. 8 is a diagram showing an example of a functional block diagram of the mobile terminal according to the present example embodiment.

FIG. 9 is a diagram showing an example of a functional block diagram of the relay apparatus according to the present example embodiment.

FIG. 10 is a diagram showing an example of a functional block diagram of the payment apparatus according to the present example embodiment.

FIG. 11 is a sequence diagram showing an example of a process flow of the payment system according to the present example embodiment.

FIG. 12 is a diagram showing an example of a hardware configuration of an apparatus according to the present example embodiment.

FIG. 13 is a sequence diagram showing an example of a process flow of the payment system according to the present example embodiment.

FIG. 14 is a sequence diagram showing an example of a process flow of the payment system according to the present example embodiment.

### DESCRIPTION OF EMBODIMENTS

### First Example Embodiment

“Overview of Payment System”

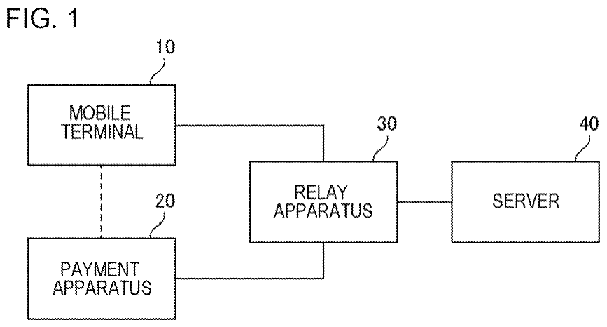

First, an overview of a payment system according to the present example embodiment will be described with reference to FIG. 1. The payment system includes a payment apparatus 20 and a relay apparatus 30. The payment system may further include at least one of a mobile terminal 10 and a server 40.

The payment apparatus 20 is installed in a retailer's store that adopts the payment system according to the present example embodiment. The payment apparatus 20 is, for example, a point of sales (POS) terminal. A program that performs functions to be described below in addition to a function as a normal POS system is installed in the payment apparatus 20.

The server 40 is a system of a credit card company and performs various processes relating to a credit card settlement. Hereinafter, the “credit card” may be simply referred to as a “card”.

The mobile terminal 10 is a terminal owned by each user. The mobile terminal 10 is, for example, a smartphone, a tablet terminal, a mobile phone, or the like. A predetermined application (hereinafter, “card payment application”) provided by a retailer adopting a payment system according to the present example embodiment is installed in the mobile terminal 10.

The relay apparatus 30 relays information between the apparatuses described above.

The mobile terminal 10 and the relay apparatus 30 transmit and receive information to and from each other through a public communication network such as the Internet. Further, the relay apparatus 30 and the server 40 transmit and receive information to and from each other through the public communication network such as the Internet.

The payment apparatus 20 and the relay apparatus 30 may transmit and receive information to and from each other through a public communication network such as the Internet. However, from the viewpoint of reducing a waiting time of a user when paying with a credit card, it is preferable that the payment apparatus 20 and the relay apparatus 30 communicate with each other by using the following method. For example, the payment apparatus 20 and the relay apparatus 30 may be installed in the same local area network (LAN) and may transmit and receive information to and from each other through the LAN. In addition to this, the payment apparatus 20 and the relay apparatus 30 may be communicably connected to each other by a dedicated line. In addition to this, the payment apparatus 20 and the relay apparatus 30 may be installed close to each other so as to be connectable through a certain communication cable, and information may be transmitted and received through the communication cable.

“Outline of Credit Card Settlement”

Next, an outline of settlement by a credit card using the payment system according to the present example embodiment will be briefly described.

A user who wishes to pay with a credit card operates his or her mobile terminal 10 to start up a card payment application and performs an input for making an inquiry on availability of a credit card, before making a payment. According to the input, the mobile terminal 10 transmits the inquiry on the availability of the credit card to the server 40 of a credit card company (hereinafter, may be simply referred to as a “server 40”) through the relay apparatus 30. The inquiry includes credit card information (card number, expiration date, name, authentication code, and so on).

The server 40 decides whether or not the credit card is available based on the received credit card information. For example, the server 40 performs a credit inquiry of a user thereof (card user), decision on whether or not an available amount at that time is greater than a predetermined value (for example: “0”), decision on whether or not an expiration date of the credit card elapses, and so on. It should be noted that, a payment amount is not decided at this point in time, and thus, the server 40 does not determine whether or not the payment amount is less than or equal to the available amount.

Then, the server 40 transmits a response to the inquiry on the availability of the credit card to the mobile terminal 10 through the relay apparatus 30. It should be noted that, the response includes a decision result of the availability of the credit card. Further, in a case where the decision result is “credit card is available”, the available amount is included in the response.

When the decision result is “credit card is available”, the mobile terminal 10 generates and outputs a code indicating credit card information, available amount, and the like.

A user provides the code thereof at the time of subsequent payment. Then, as the payment apparatus 20 reads the code, the credit card information, the available amount, and the like are inputted to the payment apparatus 20.

The payment apparatus 20 determines whether or not settlement by a credit card is possible based on input information. Specifically, in a case where a “payment amount is less than or equal to an available amount”, the payment apparatus 20 determines that settlement by a credit card is possible. After the determination, the payment apparatus 20 outputs information indicating that settlement by a credit card is possible. Further, the payment apparatus 20 transmits a request for settlement by a credit card to the server 40. The request includes a payment amount and the like.

It should be noted that, when the payment apparatus 20 outputs “information indicating that settlement by a credit card is possible”, a user (customer) can leave the place without waiting for completion of the settlement made by the server 40 thereafter.

“Configuration of Each Apparatus”

Next, a configuration of each apparatus will be described in detail.

“Mobile Terminal 10”

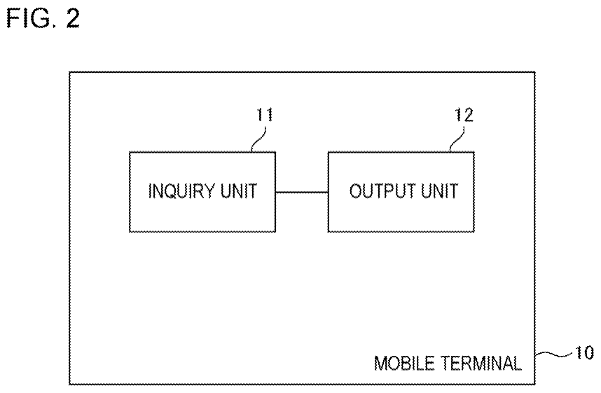

FIG. 2 shows an example of a functional block diagram of the mobile terminal 10. As shown in the figure, the mobile terminal 10 includes an inquiry unit 11 and an output unit 12. By installing a predetermined application (card payment application) in the mobile terminal 10, functions of the inquiry unit 11 and the output unit 12 are given to the mobile terminal 10. That is, the card payment application is a program for causing a computer of the mobile terminal 10 to function as the inquiry unit 11 and the output unit 12.

It should be noted that, at any timing after the card payment application is installed, a user of the application starts up the application and performs a user information registration process. In the registration process, a user can register a name, a date of birth, one or more pieces of credit card information (card number, expiration date, name, authentication code, and the like), and so on. The registered credit card information may be stored in the mobile terminal 10 or may be stored in the relay apparatus 30.

Further, by performing the registration process, a user ID (identifier) for identifying a user who uses the card payment application is issued. Hereinafter, the user ID for identifying the user who uses the card payment application is simply referred to as a “user ID”. The relay apparatus 30 manages the user ID. Further, device information (for example, telephone number, device token, address information, and the like) for identifying the mobile terminal 10 is registered in the relay apparatus 30 in association with the user ID in the registration process. By the registration, the relay apparatus 30 can transmit predetermined information to the mobile terminal 10 of a predetermined user.

The inquiry unit 11 shown in FIG. 2 transmits an inquiry on availability of a credit card to the relay apparatus 30 according to a user input. Then, the inquiry unit 11 receives a response to the inquiry from the relay apparatus 30. At a point in time when the card payment application is installed, information (for example: address information) for identifying the relay apparatus 30 may be stored in the mobile terminal 10.

It should be noted that, the relay apparatus 30 that receives the inquiry on the availability of the credit card from the mobile terminal 10 transmits the inquiry on the availability of the credit card to the server 40. Then, the relay apparatus 30 receives a response to the inquiry from the server 40 and transmits the response received from the server 40 to the mobile terminal 10.

The inquiry includes credit card information. For example, a user may specify one of pieces of the credit card information registered previously and input the inquiry on the availability of the credit card.

In a case where the credit card information is stored in the mobile terminal 10, the inquiry unit 11 reads the specified credit card information and adds the credit card information to the inquiry on the availability of the credit card to transmit the inquiry. In this case, the relay apparatus 30 transmits the received inquiry on the availability of the credit card to the server 40.

In a case where the credit card information is stored in the relay apparatus 30, the inquiry unit 11 includes the information for identifying the specified credit card information in the inquiry on the availability of the credit card, and transmits the information. In this case, the relay apparatus 30 reads the credit card information identified by the received information, includes the credit card information in the inquiry on the availability of the credit card, and transmits the information to the server 40.

In addition to this, a user may input the credit card information when inputting the inquiry on the availability of the credit card. Then, the inquiry unit 11 may transmit an inquiry including the credit card information inputted in this way to the relay apparatus 30.

A response to the inquiry includes a “decision result of the availability of the credit card”. Further, in a case where the decision result is that a “credit card is available”, the response to the inquiry includes an available amount. The available amount is a value obtained by subtracting an amount used within a predetermined period (for example: 1 month) set for the card user from an upper usage limit of the credit card within the predetermined period.

In a case where the response to the inquiry is that a “credit card is available”, the output unit 12 outputs card-related information including the available amount included in the response. The card-related information can include credit card information and a user ID in addition to the available amount. It should be noted that, the card-related information may further include information for identifying the relay apparatus 30 (for example, address information).

The output unit 12 can generate, for example, a code (for example: two-dimensional code, bar code, and so on) indicating the card-related information and output the code. The output may be displaying on a display or may be printing through a printer.

“Relay Apparatus 30”

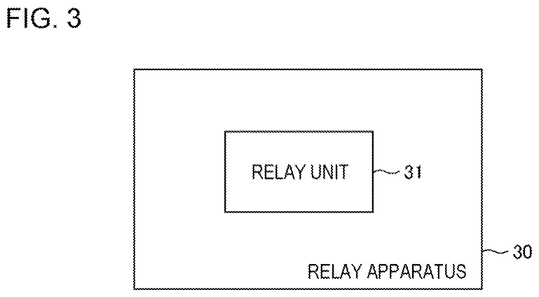

FIG. 3 shows an example of a functional block diagram of the relay apparatus 30. As shown in the figure, the relay apparatus 30 includes a relay unit 31.

When receiving the inquiry on the availability of the credit card from the mobile terminal 10, the relay unit 31 transmits the inquiry on the availability of the credit card to the server 40. It should be noted that, the relay unit 31 can determine which credit card company's server 40 the inquiry is transmitted to based on the credit card information included in the inquiry.

Then, when receiving a response to the inquiry from the server 40, the relay unit 31 transmits the response to the mobile terminal 10. It should be noted that, the response to the inquiry includes a decision result of the availability of the credit card. Further, in a case where the decision result is “credit card is available”, the available amount is included in the response.

Further, the relay unit 31 may receive a request for settlement by a credit card from the payment apparatus 20 and transmit the request to the server 40. Then, the relay unit 31 may receive a response to the request from the server 40 and transmit the response to the payment apparatus 20. The request includes a payment amount and credit card information. The relay unit 31 can determine which credit card company's server 40 a request for settlement is transmitted to based on the credit card information.

“Server 40”

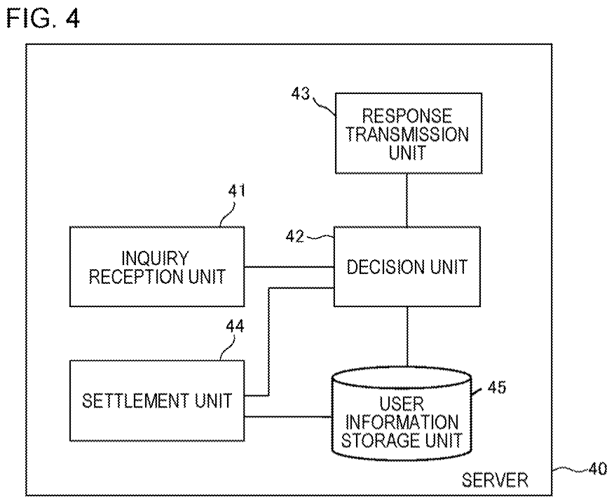

FIG. 4 shows an example of a functional block diagram of the server 40. As shown in the figure, the server 40 includes an inquiry reception unit 41, a decision unit 42, a response transmission unit 43, a settlement unit 44, and a user information storage unit 45.

The user information storage unit 45 stores information on a card user. For example, the user information storage unit 45 stores an upper usage limit of a credit card within a predetermined period, a use history of the credit card, and the so on in addition to name, address, age, gender, occupation, annual income, and so on of each card user.

The inquiry reception unit 41 receives an inquiry on availability of a credit card from the relay apparatus 30.

The decision unit 42 decides the availability of the credit card according to the inquiry on the availability of the credit card. For example, the decision unit 42 identifies a card user based on credit card information. Then, the decision unit 42 performs a credit inquiry of the card user, decision as to whether or not an available amount at that time is greater than a predetermined value (for example: “0”), decision as to whether or not an expiration date of the credit card elapses, and so on. The decision made by the decision unit 42 can be implemented by adopting a certain technique.

The response transmission unit 43 transmits a response to the inquiry on the availability of the credit card to the relay apparatus 30. The response includes a decision result of the availability of the credit card made by the decision unit 42. Further, in a case where the decision result is “credit card is available”, the available amount is included in the response.

The settlement unit 44 makes settlement by a credit card according to a request from the payment apparatus 20. The request includes a payment amount, credit card information, and so on. The settlement made by the settlement unit 44 can be implemented by adopting all kinds of technologies.

It should be noted that, the settlement unit 44 may update the card user information stored in the user information storage unit 45. Specifically, when the settlement by the credit card is completed, the settlement unit 44 may newly describe information (date and time, used store, payment amount, and so on) on a current use of a credit card in a use history of the credit card.

“Payment Apparatus 20”

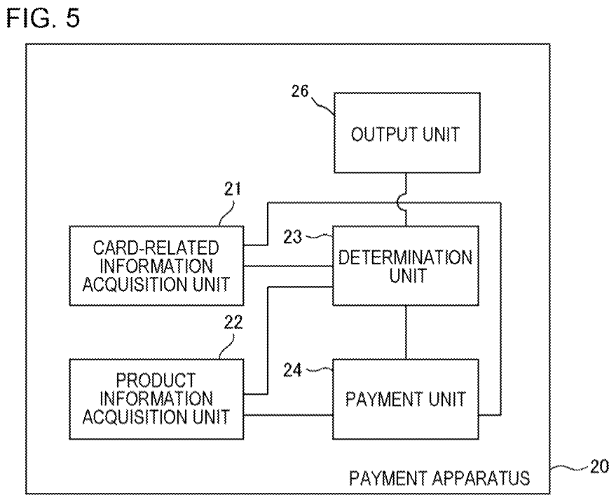

FIG. 5 shows an example of a functional block diagram of the payment apparatus 20. As shown in the figure, the payment apparatus 20 includes a card-related information acquisition unit 21, a product information acquisition unit 22, a determination unit 23, a payment unit 24, and an output unit 26.

The product information acquisition unit 22 acquires product identification information of one or a plurality of products to be paid for. The payment apparatus 20 includes input apparatuses such as a code reader, a touch panel display, physical buttons, and a microphone. The product identification information is inputted to the product information acquisition unit 22 through the input apparatus. In addition to this, the payment apparatus 20 may include a camera. Then, the payment apparatus 20 may analyze an image generated by a camera and identify products included in the image by using a technique such as pattern matching. Then, the product identification information of the identified product may be inputted to the product information acquisition unit 22. As such, the product identification information on products to be paid for may be inputted to the product information acquisition unit 22 by using the image analysis technique.

When acquiring the product identification information, the product information acquisition unit 22 acquires product information (selling price and so on) corresponding to the product identification information from a product master and registers the product information in the payment apparatus 20 as a payment target.

The card-related information acquisition unit 21 includes a code reader and acquires card-related information by reading a code indicating card-related information outputted from the mobile terminal 10. As described above, the card-related information includes credit card information, an available amount, a user ID, information for identifying the relay apparatus 30, and so on.

The determination unit 23 determines whether or not settlement by a credit card is possible based on the card-related information acquired by the card-related information acquisition unit 21. In a case where “a payment amount is less than or equal to the available amount”, the determination unit 23 determines that the settlement by the credit card is possible. Meanwhile, in a case where the payment amount is not “less than or equal to the available amount”, the determination unit 23 determines that the settlement by the credit card is not possible. It should be noted that, the payment amount is an amount obtained by adding a tax to the sum of prices of the products registered as payment targets by the product information acquisition unit 22.

The payment unit 24 performs a payment process based on a determination result of the determination unit 23. In a case where the determination result of the determination unit 23 is that “settlement by a credit card is possible”, the payment unit 24 makes the settlement by the credit card. Specifically, the payment unit 24 transmits a request for the settlement by the credit card to the server 40 of a credit card company through the relay apparatus 30 or without passing through the relay apparatus 30, and receives a reply to the request. In a case where the request for settlement is transmitted to the server 40 of a credit card company without passing through the relay apparatus 30, the payment unit 24 can determine to which credit card company's server 40 to transmit the request for settlement based on the credit card information acquired by the card-related information acquisition unit 21.

The request for settlement includes a payment amount. Further, the request for settlement may include the credit card information acquired by the card-related information acquisition unit 21.

Meanwhile, in a case where the determination result of the determination unit 23 is “settlement by a credit card is not possible”, the payment unit 24 performs a process for payment by means other than a credit card. A payment by means other than the credit card includes, for example, a payment in cash, a payment using points, and so on, but is not limited thereto. The payment unit 24 can make a payment by means other than the credit card by using any technology.

The output unit 26 outputs a determination result of the determination unit 23, that is, a determination result of whether or not settlement by a credit card is possible. The output unit 26 can output the determination result through an output apparatus such as a display, a speaker, or a lamp.

It should be noted that, the output unit 26 can output the determination result of the determination unit 23 before a payment process by the payment unit 24 is completed. For example, the output unit 26 can output the determination result of the determination unit 23 before the payment unit 24 transmits a request for settlement by a credit card to the server 40 of a credit card company or before receiving a reply to the request.

“Flow of Process”

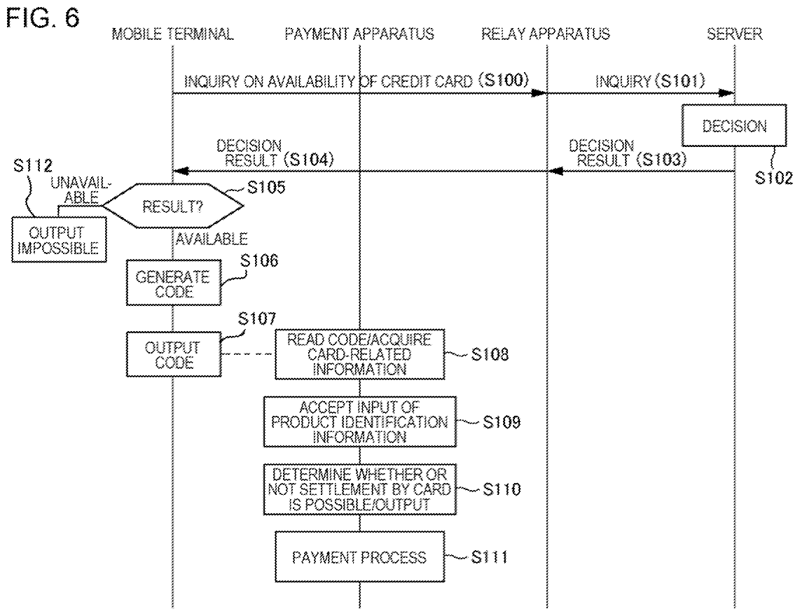

Next, an example of a flow of a process of settlement by a credit card using the payment system will be described with reference to a sequence diagram of FIG. 6.

A user who wishes to pay with a credit card operates his or her mobile terminal 10 to start up a card payment application before making a payment. Then, the user performs an input for making an inquiry on availability of a credit card in the application for card payment.

Then, the mobile terminal 10 transmits the inquiry on the availability of the credit card to the relay apparatus 30 (S100). The relay apparatus 30 transmits the received inquiry on the availability of the credit card to the server 40 of a credit card company (S101).

It should be noted that, the inquiry includes credit card information (card number, expiration date, name, authentication code, and so on). The relay apparatus 30 can determine which credit card company's server 40 the inquiry is transmitted to based on the credit card information.

As described above, the credit card information may be stored previously in the mobile terminal 10 or the relay apparatus 30, and the credit card information may be inputted to the mobile terminal 10 when an input is performed to make an inquiry on the availability of the credit card.

The server 40 decides the availability of the credit card based on the received credit card information (S102). For example, the server 40 performs a credit inquiry of a card user thereof, decision as to whether or not an available amount at that time is greater than a predetermined value (for example: “0”), decision as to whether or not an expiration date of the credit card elapses, and so on. It should be noted that, a payment amount is not decided at this point in time, and thus, the server 40 does not determine whether or not the payment amount is less than or equal to the available amount.

Then, the server 40 transmits a response to the inquiry on the availability of the credit card to the relay apparatus 30 (S103). The relay apparatus 30 transmits the received response to the mobile terminal 10 (S104). The response includes a decision result of the availability of the credit card. Further, in a case where the decision result is “credit card is available”, the available amount is included in the response.

In a case where the decision result is that “a credit card is unavailable” (“unavailable” in S105), the mobile terminal 10 outputs information indicating that the credit card is unavailable (S112).

Meanwhile, when the decision result is that “a credit card is available” (“available” in S105), the mobile terminal 10 generates a code indicating card-related information (S106) and outputs the code (S107). For example, the mobile terminal 10 may generate a two-dimensional code indicating the card-related information to display on a display.

The user provides the code outputted in S107 at the time of subsequent payment at a cash register. Then, as the payment apparatus 20 reads the code, the card-related information is inputted to the payment apparatus 20 (S108).

Further, the payment apparatus 20 acquires product identification information of one or a plurality of products to be paid for (S109). When acquiring the product identification information, the payment apparatus 20 acquires product information (selling price and so on) corresponding to the product identification information from a product master and registers the product information as a payment target.

Then, the payment apparatus 20 determines whether or not settlement by a credit card is possible based on the card-related information acquired in S108 and content inputted in S109, and outputs the determination result (S110).

Specifically, in a case where a “payment amount is less than or equal to an available amount”, the payment apparatus 20 determines that settlement by a credit card is possible. Meanwhile, in a case where a payment amount is not less than or equal to the available amount, the payment apparatus 20 determines that the settlement by the credit card is not possible.

The payment apparatus 20 may display, for example, a determination result of whether or not the settlement by the credit card is possible on a display. Then, in a case where it is determined that the settlement by the credit card is possible, the payment apparatus 20 may output a receipt showing payment content before S111.

It should be noted that, the payment apparatus 20 determines that the settlement by the credit card is possible in a case where the decision result by the server 40 is that “a credit card is available” and “the payment amount is less than or equal to the available amount”. In a case where this condition is satisfied, the settlement by the credit card made by the server 40 of the credit card company is successful. Due to this, there is no problem even if a transaction with a user is completed by performing an output or the like of a receipt before settlement by a credit card is completed by the server 40 of the credit card company.

Next, the payment apparatus 20 performs a payment process based on the determination result in S110 (S11). In a case where the determination result is that “settlement by a credit card is possible”, the payment apparatus 20 makes the settlement by the credit card. Specifically, the payment apparatus 20 transmits a request for settlement to the server 40 of a credit card company through the relay apparatus 30 or without passing through the relay apparatus 30, and receives a reply to the request. The request for settlement includes a payment amount. Further, the request for settlement may include the credit card information acquired in S108.

Meanwhile, in a case where the determination result is that “settlement by a credit card is not possible”, the payment apparatus 20 performs a process for payment by means other than the credit card. A payment by means other than the credit card includes, for example, a payment in cash, a payment using points, and so on, but is not limited thereto.

Here, a modification example will be described. A process sequence of S108, S109, and S110 is not limited to the shown sequence. In the shown example, the card-related information is inputted to the payment apparatus 20 before an input of the product identification information (registration of a product to be paid for) starts. As another example, after the input of the product identification information (registration of a product to be paid for) is completed, for example, after an input for shifting to a payment process (for example: pressing a “calculation start” button) is performed, card-related information may be inputted to the payment apparatus 20. In addition to this, the card-related information may be inputted to the payment apparatus 20 at a certain timing when the input of the product identification information starts and before the input is completed.

Further, in the shown example, the payment apparatus 20 determines whether or not settlement can be made by a card (determines whether or not a payment amount is less than or equal to an available amount, and so on) after an input (registration of the product to be paid for) of product identification information is completed. As another example, the payment apparatus 20 may determine whether or not settlement can be made by a card based on the payment amount at that time and the available amount each time new product identification information is input (every time the product information acquisition unit 22 acquires new product identification information). In a case of this example, if an input (for example: pressing the “calculation start” button) for shifting to the payment process is performed, the latest determination result at that time is finalized as the final determination result. Then, the payment apparatus 20 outputs the finalized determination result and executes payment process based on the determination result.

“Operation and Advantageous Effect”

With the payment system according to the present example embodiment described above, the payment apparatus 20 can acquire a decision result of whether or not a credit card is available, which is made by the server 40, and a result as to whether or not a payment amount is less than or equal to an available amount, without communicating with the server 40 of a credit card company. That is, the payment apparatus 20 can acquire a material for determining whether or not settlement by a credit card is possible without communicating with the server 40 of the credit card company. Due to this, the payment apparatus 20 can determine whether or not the settlement by the credit card is possible without communicating with the server 40 of the credit card company.

It should be noted that, in a case where a condition for successful settlement by a credit card at the server 40 of the credit card company is satisfied, the payment apparatus 20 determines that the settlement by the credit card is possible. Due to this, there is no problem that even if a transaction with a user is completed by making an output or the like of a receipt before the settlement by the credit card is completed by the server 40 of a credit card company in a case where the payment apparatus 20 determines that the settlement by the credit card is possible.

In a case of doing so, a user can complete the payment with the credit card without waiting for completion of a communication between the payment apparatus 20 and the server 40, or without waiting for completion of a process performed by the server 40. As a result, with the payment system of the present example embodiment, it is possible to reduce a waiting time of a user when a payment is made with a credit card.

### Second Example Embodiment

In a payment system according to the present example embodiment, a unit that inputs card-related information to the payment apparatus 20 is different from the unit according to the first example embodiment. Other configurations are the same as in the first example embodiment.

The output unit 12 (see FIG. 2) of the mobile terminal 10 transmits card-related information to the payment apparatus 20 through a short-range wireless communication (FeliCa, MIFARE, NFC, or the like). The card-related information acquisition unit 21 (see FIG. 5) of the payment apparatus 20 receives the card-related information from the mobile terminal 10 through the short-range wireless communication. Other configurations of the mobile terminal 10 (see FIG. 2) and the payment apparatus 20 (see FIG. 5) are the same as in the first example embodiment. Further, configurations of the relay apparatus 30 (see FIG. 3) and the server 40 (see FIG. 4) are the same as in the first example embodiment.

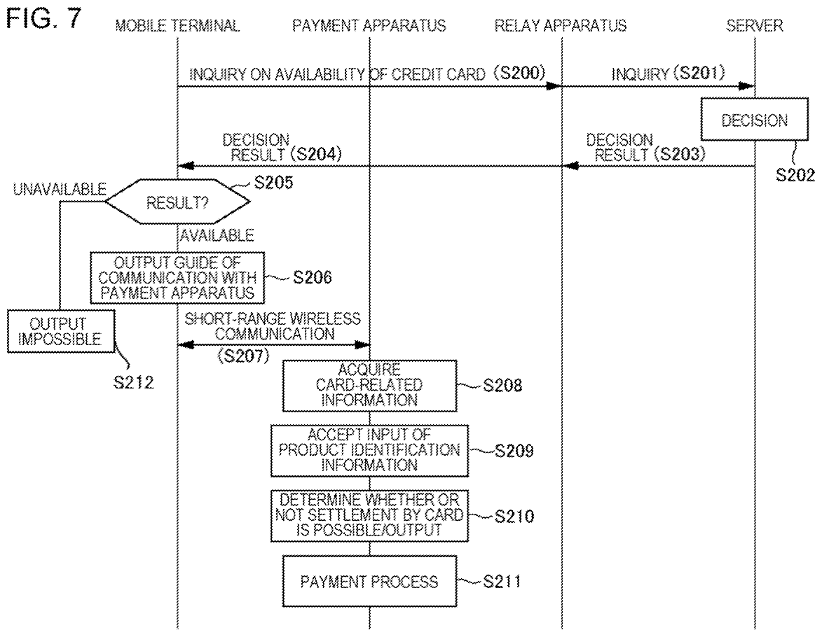

A sequence diagram of FIG. 7 shows an example of a flow of a process of settlement by a credit card using the payment system. S206 and S207 are different therefrom as compared with the sequence diagram of FIG. 6 described in the first example embodiment. Other processes are the same as in the first example embodiment.

In S206, the mobile terminal 10 displays a guide such as “please let communication be made with the payment apparatus 20 to transmit card-related information to the payment apparatus 20” on, for example, a display. Thereafter, a user touches the mobile terminal 10 to a predetermined position of the payment apparatus 20 or brings the mobile terminal 10 closer to the payment apparatus 20, and thus, if the mobile terminal 10 and the payment apparatus 20 enters a state in which a short-range wireless communication is possible, the card-related information stored in the mobile terminal 10 is transmitted to the payment apparatus 20 (S207).

According to the payment system of the present example embodiment, the same operation and advantageous effects as in the first example embodiment can be obtained.

### Third Example Embodiment

A payment system according to the present example embodiment is different from the payment systems according to the first and second example embodiments in that there is provided a function of authenticating that a user who operates the mobile terminal 10 is a legitimate user. Description will be made below. It should be noted that, a configuration of the server 40 is the same as the configurations according to the first and second example embodiments.

“Mobile Terminal 10”

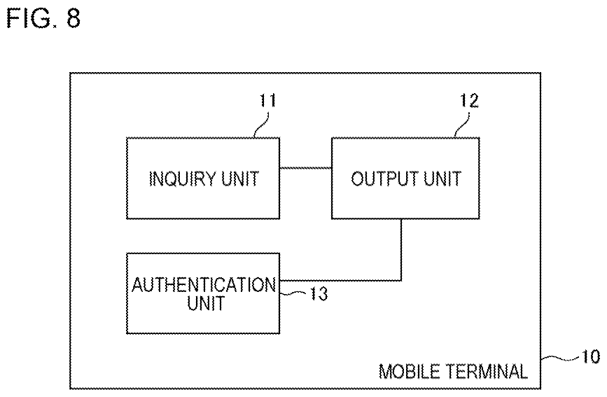

FIG. 8 shows an example of a functional block diagram of the mobile terminal 10. As shown in the figure, the mobile terminal 10 includes the inquiry unit 11, the output unit 12, and an authentication unit 13. By installing a predetermined application (card payment application) in the mobile terminal 10, functions of the inquiry unit 11, the output unit 12, and the authentication unit 13 are given to the mobile terminal 10. That is, the card payment application is a program for causing a computer of the mobile terminal 10 to function as the inquiry unit 11, the output unit 12, and the authentication unit 13.

Configurations of the inquiry unit 11 and the output unit 12 is the same as the configurations according to the first and second example embodiments.

The authentication unit 13 performs a user authentication process. The authentication unit 13 can perform the user authentication process according to a request from the relay apparatus 30. The authentication unit 13 can perform any one of following user authentication processes 1 to 4.

“User Authentication Process 1”

After installing the card payment application, a user starts up the application and performs a process of registering his or her own biometric information (for example, fingerprint, voiceprint, iris, and so on) as authentication information. The registered biometric information is stored in the mobile terminal 10.

The authentication unit 13 prompts the user to input biometric information at a predetermined timing, and collates the inputted biometric information with the previously registered authentication information, thereby, deciding whether or not a user who operates the mobile terminal 10 is a legitimate user. The authentication unit 13 may transmit an authentication result to the relay apparatus 30. The authentication may be implemented by a so-called fast identity online (FIDO) protocol. In a case of this example, the biometric information stays in an apparatus of the mobile terminal 10 and does not leak to the outside of the mobile terminal 10. Due to this, this example is excellent in terms of security.

“User Authentication Process 2”

After installing a card payment application, a user starts up the application and registers his or her own biometric information as authentication information. The registered biometric information is stored in the relay apparatus 30.

The authentication unit 13 prompts the user to input the biometric information at a predetermined timing and transmits the inputted biometric information to the relay apparatus 30. The relay apparatus 30 decides whether or not a user who operates the mobile terminal 10 is a legitimate user by collating the previously registered authentication information with the received biometric information. The relay apparatus 30 may transmit an authentication result to the mobile terminal 10.

“User Authentication Process 3”

After installing a card payment application, a user starts up the application and sets a password. Then, the authentication information including the set password and a user ID is stored in the mobile terminal.

The authentication unit 13 prompts the user to input the user ID and the password at a predetermined timing. Then, the authentication unit 13 decides whether or not a user who operates the mobile terminal 10 is a legitimate user by collating the inputted user ID and password with the previously registered authentication information. The authentication unit 13 may transmit an authentication result to the relay apparatus 30. In a case of this example, the password stays in an apparatus of the mobile terminal 10 and does not leak to the outside of the mobile terminal 10. Due to this, this example is excellent in terms of security.

“User Authentication Process 4”

After installing a card payment application, a user starts up the application and sets a password. Then, authentication information including a set password and a user ID is stored in the relay apparatus 30.

The authentication unit 13 prompts the user to input the user ID and the password at a predetermined timing. Then, the authentication unit 13 transmits the inputted user ID and password to the relay apparatus 30. The relay apparatus 30 decides whether or not a user who operates the mobile terminal 10 is a legitimate user by collating the previously registered authentication information with the received user ID and password. The relay apparatus 30 may transmit an authentication result to the mobile terminal 10.

“Relay Apparatus 30”

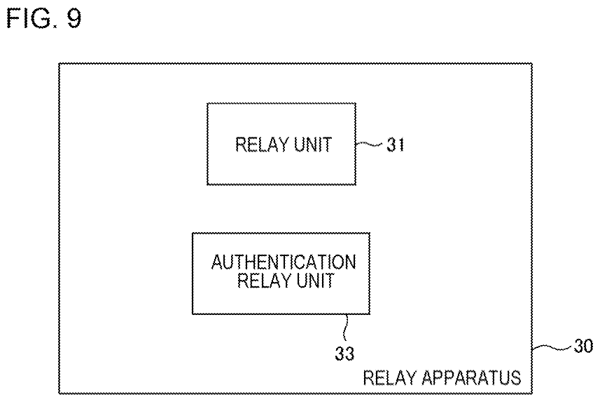

FIG. 9 shows an example of a functional block diagram of the relay apparatus 30. As shown in the figure, the relay apparatus 30 includes the relay unit 31 and an authentication relay unit 33. A configuration of the relay unit 31 is the same as the configuration according to the first and second example embodiments.

The authentication relay unit 33 acquires a user ID from the payment apparatus 20. Then, the authentication relay unit 33 transmits a user authentication request to the mobile terminal 10 corresponding to the user ID. As described in the first example embodiment, device information for identifying the mobile terminal 10 is registered in the relay apparatus 30 in association with the user ID by a user information registration process after a card payment application is installed. The authentication relay unit 33 determines the mobile terminal 10 corresponding to the user ID acquired from the payment apparatus 20 based on a corresponding relationship.

In a case where the mobile terminal 10 performs the user authentication processes 1 or 3, the authentication relay unit 33 receives an authentication result from the mobile terminal 10. Then, the authentication relay unit 33 transmits a reply to the received authentication result to the payment apparatus 20.

It should be noted that, in a case where the mobile terminal 10 performs the user authentication process 2 or 4, the authentication relay unit 33 performs the authentication process based on the information received from the mobile terminal 10. Then, the authentication relay unit 33 transmits a reply to the authentication result to the payment apparatus 20.

“Payment Apparatus 20”

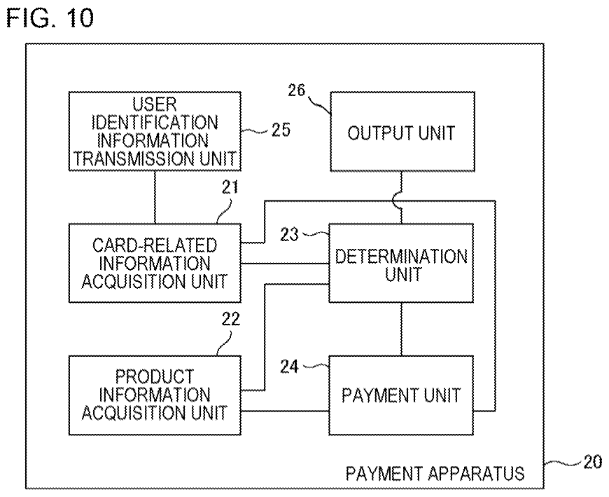

FIG. 10 shows an example of a functional block diagram of the payment apparatus 20. As shown in the figure, the payment apparatus 20 includes the card-related information acquisition unit 21, the product information acquisition unit 22, the determination unit 23, the payment unit 24, a user identification information transmission unit 25, and the output unit 26. Configurations of the card-related information acquisition unit 21, the product information acquisition unit 22, the payment unit 24, and the output unit 26 are the same as in the first and second example embodiments.

The user identification information transmission unit 25 transmits a user ID included in the card-related information to the relay apparatus 30 identified by information for identifying the relay apparatus 30 included in the card-related information.

In a case where “a payment amount is less than or equal to an available amount” and “a result of the authentication process is successful in authentication”, the determination unit 23 determines that settlement by a credit card is possible. Meanwhile, in a case where “the payment amount is not less than or equal to the available amount” or “the result of authentication process is an authentication failure”, the determination unit 23 determines that the settlement by the credit card is not possible. Other configurations of the determination unit 23 are the same as in the first and second example embodiments.

“Flow of Process”

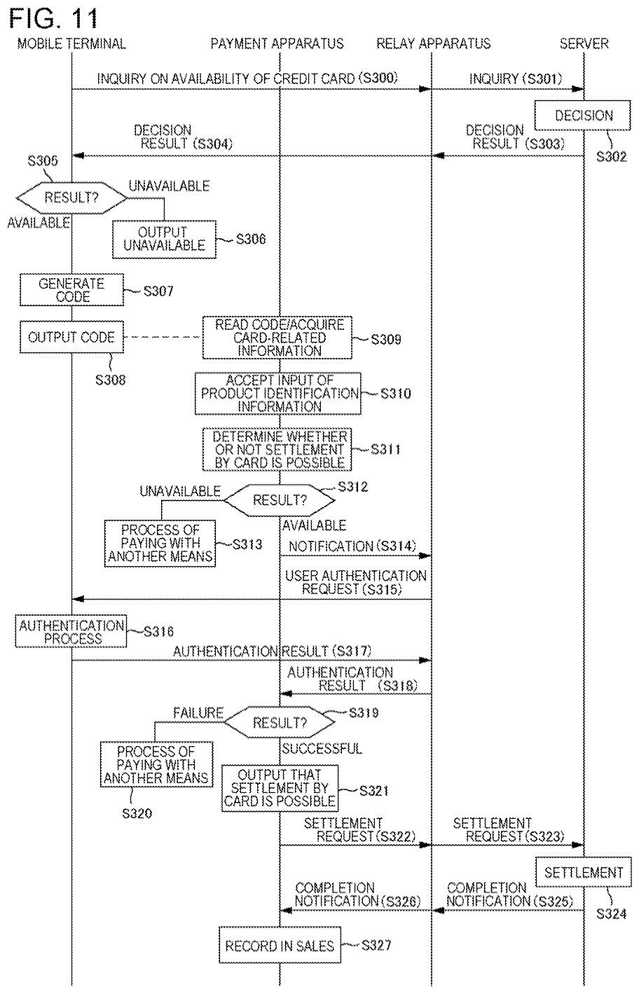

Next, an example of a flow of a process of settlement by a credit card using the payment system will be described with reference to a sequence diagram of FIG. 11.

A user who wishes to pay with a credit card operates his or her mobile terminal 10 to start up a card payment application before making a payment. Then, the user performs an input for making an inquiry on availability of a credit card in the application for card payment.

Then, the mobile terminal 10 transmits an inquiry on availability of a credit card to the relay apparatus 30 (S300). The relay apparatus 30 transmits the received inquiry on the availability of the credit card to the server 40 of a credit card company (S301).

It should be noted that, the inquiry includes credit card information (card number, expiration date, name, authentication code, and so on). The relay apparatus 30 can determine which credit card company's server 40 the inquiry is transmitted to based on the credit card information.

As described above, the credit card information may be stored previously in the mobile terminal 10 or the relay apparatus 30, and the credit card information may be inputted to the mobile terminal 10 when an input is performed to make an inquiry on the availability of the credit card.

The server 40 decides whether or not the credit card is available based on the received credit card information (S302). For example, the server 40 performs a credit inquiry of a card user thereof, decision as to whether or not an available amount at that time is greater than a predetermined value (for example: “0”), or decision as to whether or not an expiration date of the credit card elapses, and so on. It should be noted that, a payment amount is not decided at this point in time, and thus, the server 40 does not determine whether or not the payment amount is less than or equal to the available amount.

Then, the server 40 transmits a response to the inquiry on the availability of the credit card to the relay apparatus 30 (S303). The relay apparatus 30 transmits the received response to the mobile terminal 10 (S304). The response includes a decision result of the availability of the credit card. Further, in a case where the decision result is “credit card is available”, the available amount is included in the response.

In a case where the decision result is that “a credit card is unavailable” (“unavailable” in S305), the mobile terminal 10 outputs information indicating that the credit card is unavailable (S306).

Meanwhile, in a case where the decision result is that “a credit card is available” (“available” in S305), the mobile terminal 10 generates a code indicating card-related information (S307) and outputs the code (S308). For example, the mobile terminal 10 may generate a two-dimensional code indicating the card-related information to display on a display.

A user provides the code outputted in S308 at the time of subsequent payment at a cash register. Then, the payment apparatus 20 reads the code, and thereby the card-related information is inputted to the payment apparatus 20 (S309).

Further, the payment apparatus 20 acquires product identification information of one or a plurality of products to be paid for (S310). When acquiring the product identification information, the payment apparatus 20 acquires product information (selling price and so on) corresponding to the product identification information from a product master and registers the product information as a payment target.

Then, the payment apparatus 20 performs a first determination on whether or not settlement by a credit card is possible based on the card-related information acquired in S309 and content inputted in S310, and outputs the determination result (S311).

In the first determination, in a case where “a payment amount is less than or equal to an available amount, the payment apparatus 20 determines that the settlement by the credit card is possible. Meanwhile, in a case where a payment amount is not less than or equal to the available amount, the payment apparatus 20 determines that the settlement by the credit card is not possible.

In a case where a determination result of the first determination of the payment apparatus 20 is that “settlement by a credit card is possible” (“possible” in S312), the payment apparatus 20 notifies the relay apparatus 30 to that effect (S314). Information (address information) for identifying the relay apparatus 30 may be stored previously in the payment apparatus 20. Alternatively, the card-related information acquired in S309 may include information (address information) for identifying the relay apparatus 30. It should be noted that, the user ID may be included in the notification in S314.

The relay apparatus 30 that receives the notification transmits a user authentication request to the mobile terminal 10 corresponding to the received user ID (S315).

Thereafter, the mobile terminal 10 performs a user authentication process according to the request from the relay apparatus 30 (S316). For example, the mobile terminal 10 prompts a user to input biometric information. Then, the inputted biometric information is collated with the authentication information previously stored in the mobile terminal 10, and an authentication result indicating the collation result is transmitted to the relay apparatus 30 (S317). The relay apparatus 30 transmits the authentication result received in S317 to the payment apparatus 20 (S318).

In a case where a result of the authentication process is successful in authentication (“successful” in S319), the payment apparatus 20 determines that settlement by a credit card is possible. Then, the payment apparatus 20 displays, for example, on a display that the settlement by the credit card is possible (S321). In this case, the payment apparatus 20 may output a receipt showing payment content before settlement processes in and after S322 is completed.

Thereafter, the payment apparatus 20 transmits a request for the settlement by the credit card to the relay apparatus 30 (S322). The relay apparatus 30 transmits the received request for settlement to the server 40 (S323). The request for settlement includes a payment amount, credit card information, and so on.

Thereafter, the server 40 performs a process of settlement by a credit card (S324) and transmits a settlement completion notification to the relay apparatus 30 (S325). The relay apparatus 30 transmits the settlement completion notification to the payment apparatus 20 (S326). The payment apparatus 20 records sales according to the notification (S327).

It should be noted that, in a case where a determination result of the first determination in S311 is that the settlement by the credit card is impossible (“impossible” in S312), or in a case where a result of the authentication process received in S318 is authentication failure (“failure” in S319), the payment apparatus 20 performs a payment process by means other than a credit card (S313 and S320).

Here, a modification example will be described. A process sequence of S309, S310, and S311 is not limited to the sequence shown in the figure. In the shown example, the card-related information is inputted to the payment apparatus 20 before an input of the product identification information (registration of a product to be paid for) starts. As another example, after the input of the product identification information (registration of a product to be paid for) is completed, for example, after an input for shifting to a payment process (for example: pressing a “calculation start” button) is performed, card-related information may be inputted to the payment apparatus 20. In addition to this, the card-related information may be inputted to the payment apparatus 20 at a certain timing when the input of the product identification information starts and before the input is completed.

Further, in the shown example, the payment apparatus 20 determines whether or not settlement can be made by a card (determines whether or not a payment amount is less than or equal to an available amount, and so on) after an input (registration of the product to be paid for) of product identification information is completed. As another example, the payment apparatus 20 may determine whether or not settlement can be made by a card based on the payment amount at that time and the available amount each time new product identification information is input (every time the product information acquisition unit 22 acquires new product identification information). In a case of this example, when an input (for example: pressing a “calculation start” button) for shifting to the payment process is performed, a latest determination result at that time is finalized as a final determination result, and the payment apparatus 20 outputs the finalized determination result or performs a payment process based on the finalized determination result.

Further, in the shown example, the mobile terminal 10 generates a code indicating card-related information (S307) and outputs the code (S318), but as described in the second example embodiment, the mobile terminal 10 may perform a short-range wireless communication with the payment apparatus 20 and transmit the card-related information to the payment apparatus 20.

Further, although the example in which the mobile terminal 10 performs a user authentication process 1 is described here, the mobile terminal 10 may perform a user authentication process 2, 3, or 4.

Further, although the payment apparatus 20 transmits a user ID to the relay apparatus 30 at the time of notification of S314 here, the payment apparatus 20 may transmit the user ID to the relay apparatus 30 at another timing in or after S309.

Further, although the mobile terminal 10 performs the user authentication process according to a request from the relay apparatus 30 here, the mobile terminal 10 may perform the user authentication process at another timing. For example, the mobile terminal 10 may perform the user authentication process of S316 at a certain timing “after accepting an input for making an inquiry on availability of a credit card and before generating a code in S307”. Then, the output unit 12 may generate and output a code indicating the authentication result in addition to the card-related information, or may transmit the card-related information and the authentication result to the payment apparatus 20 through a short-range wireless communication. In this case, in S311 the payment apparatus 20 decides whether or not a payment amount is less than or equal to an available amount, and decides whether or not the authentication result is successful in authentication. Then, in a case where “the payment amount is less than or equal to the available amount” and “the result of authentication process is successful in authentication”, processes of S321 to S327 are performed. Meanwhile, in a case where “the payment amount is not less than or equal to the available amount” or “the result of authentication process is an authentication failure”, the payment process is performed by another unit in S313 or S320.

“Operation and Advantageous Effect”

According to the payment system of the present example embodiment described above, the same operation and advantageous effects as in the first and second example embodiments can be obtained. Further, according to the payment system of the present example embodiment, in a case where it is determined that a user who operates the mobile terminal 10 is a legitimate user, settlement can be made by a credit card. With the payment system of the present example embodiment described above, safety is secured.

### Fourth Example Embodiment

A payment system according to the present example embodiment is different from payment systems according to the first to third example embodiments in that a response (decision result of card availability and available amount) transmitted from the server 40 is given an expiration date. Other configurations thereof are the same as in the first to third example embodiments.

The server 40 can include an expiration date in the response (S103 in FIG. 6, S203 in FIG. 7, or S303 in FIG. 11) to an inquiry on card availability. The expiration date may be, for example, a predetermined time (for example, within 5 minutes) from a timing when the server 40 transmits a response to the inquiry on the card availability, or may be another thing other than that.

The output unit 12 of the mobile terminal 10 includes the above-described expiration date in the card-related information and outputs the information.

The determination unit 23 of the payment apparatus 20 determines that settlement by a credit card is possible in a case where “a payment amount is less than or equal to an available amount” and “the card-related information is within the expiration date”. It should be noted that, the determination unit 23 may determine that settlement by a credit card is possible in a case where the payment amount is less than or equal to the available amount, a result of an authentication process is successful in authentication, and the card-related information is within the expiration date.

Meanwhile, in a case where “the payment amount is not less than or equal to the available amount”, “the result of the authentication process is an authentication failure”, or “the card-related information is not within the expiration date”, the determination unit 23 determines that the settlement by the credit card is impossible.

Other configurations of the mobile terminal 10, the payment apparatus 20, and the server 40 are the same as in the first to third example embodiments. Further, a configuration of the relay apparatus 30 is the same as in the first to third example embodiments.

With the payment system of the present example embodiment, the same advantageous effects as in the first to third example embodiments can be obtained. Further, since the card-related information can be given an expiration date, safety of transaction is secured.

Hardware Configuration

Next, an example of a hardware configuration of each of apparatuses (the mobile terminal 10, the payment apparatus 20, the relay apparatus 30, and the server 40) will be described. Each functional unit included in each apparatus according to the present example embodiment can be implemented by any combination of hardware and software on the basis of a central processing unit (CPU) of any computer, a memory, a program loaded in the memory, a storage unit (a programs downloaded from a storage medium such as a compact disc (CD), a server on the Internet, or the like can also be stored in addition to the program stored from a step of shipping an apparatus in advance) such as a hard disk for storing the program, and an interface for network connection. Then, it will be understood by those skilled in the art that there are various modification examples of the method and apparatus for implementing the same.

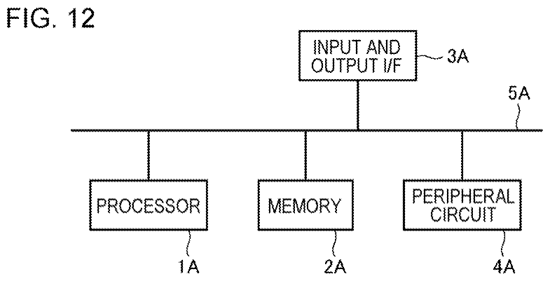

FIG. 12 is a block diagram illustrating a hardware configuration of each apparatus according to the present example embodiment. As shown in FIG. 12, each apparatus includes a processor 1A, a memory 2A, an input and output interface 3A, a peripheral circuit 4A, and a bus 5A. The peripheral circuit 4A includes various modules. A processing apparatus may not include the peripheral circuit 4A. It should be noted that, each apparatus may be composed of a plurality of physically separated apparatuses. In this case, each of the plurality of apparatuses that implement each apparatus can have the above-described hardware configuration.

The bus 5A is a data transmission path for the processor 1A, the memory 2A, the peripheral circuit 4A, and the input and output interface 3A to transmit and receive data to and from each other. The processor 1A is an arithmetic processing unit such as a CPU or a graphics processing unit (GPU). The memory 2A is a memory such as a random access memory (RAM) or a read only memory (ROM). The input and output interface 3A includes an interface for acquiring information from an input apparatus, an external apparatus, an external server, an external sensor, and so on, an interface for outputting information to an output apparatus, an external apparatus, an external server, and so on, and the like. The input apparatus is, for example, a keyboard, a mouse, a microphone, or the like. The output apparatus is, for example, a display, a speaker, a printer, a mailer, or the like. The processor 1A can output a command to each module and perform an arithmetic with an arithmetic result thereof.

### Example

Here, an example of a payment system according to the present example embodiment will be described.

First, a user information registration process will be described in which a user installs a card payment application in the mobile terminal 10 and starts up the application to perform the user information registration process. The user starts up the application and performs the user information registration process. In the registration process, a user can register a name, a date of birth, one or more pieces of credit card information (card number, expiration date, name, authentication code, and the like), and so on. Further, the user can register device information and so on in the relay apparatus 30 based on, for example, a FIDO protocol.

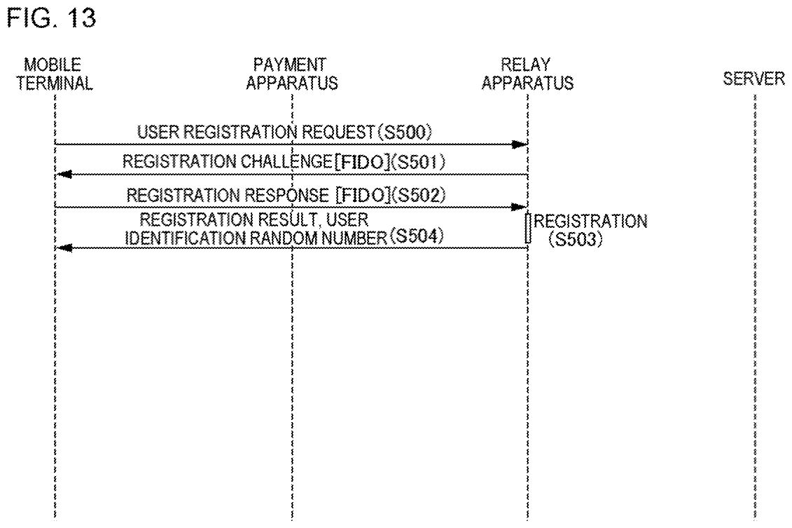

FIG. 13 shows a sequence diagram representing an example of a flow of the user information registration process. The mobile terminal 10 transmits a user registration request to the relay apparatus 30 according to a user input (S500). According to this, the relay apparatus 30 transmits a registration challenge according to the FIDO protocol to the mobile terminal 10 (S501). Next, the mobile terminal 10 transmits a registration response according to the FIDO protocol to the relay apparatus 30 (S502). Thereafter, the relay apparatus 30 performs the registration process and transmits a result thereof to the mobile terminal 10. Further, in a case where the registration is successful, the relay apparatus 30 generates a user ID (user identification random number) and notifies the mobile terminal 10.

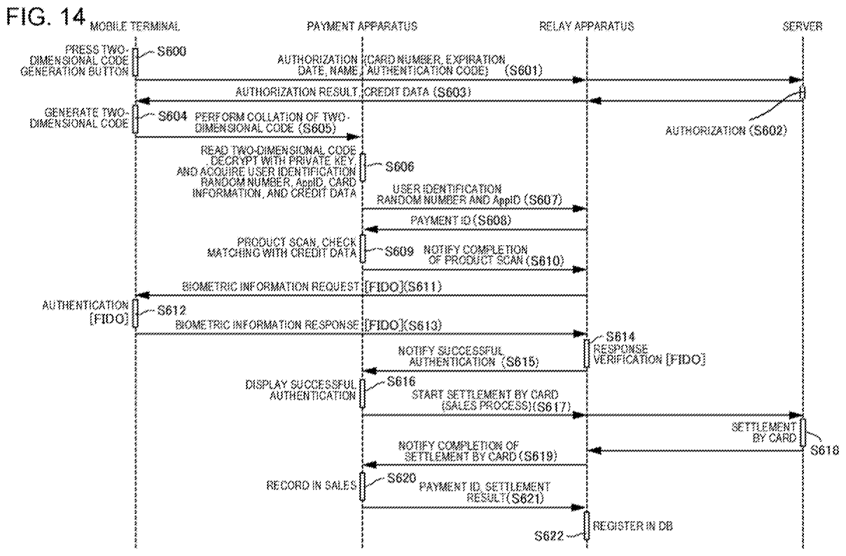

Next, a flow of a process of settlement by a credit card using the payment system will be described with reference to a sequence diagram of FIG. 14.

A user who wishes to pay with a credit card operates his or her mobile terminal 10 to start up a card payment application before making a payment. Then, the user makes pressing (an input to perform an inquiry on availability of a credit card) of a two-dimensional code generation button in the application for card payment (S600).

Then, the mobile terminal 10 transmits an authorization request (inquiry on availability of a credit card) to the server 40 of a credit card company through the relay apparatus 30 (S601). The authorization request includes credit card information (card number, expiration date, name, authorization code, and so on).

The server 40 performs authorization according to a request (S602). Then, the server 40 transmits an authorization result to the mobile terminal 10 through the relay apparatus 30 (S603). It should be noted that, in a case where the authorization result indicates “the credit card is available”, the server 40 transmits credit data including an available amount to the mobile terminal 10 through the relay apparatus 30.

In a case where the authorization result indicates that a “credit card is available”, the mobile terminal 10 generates and outputs a two-dimensional code indicating a user ID, information (AppID) for identifying the relay apparatus 30, credit card information, and an available amount (credit data) (S604).

It should be noted that, in order to prevent a malicious user from modifying the two-dimensional code, a public key cryptosystem is adopted to reduce security risk. When generating the two-dimensional code, information to be coded is encrypted with a public key (it is assumed that the public key is previously included when installed as one of modules of a smartphone application), and then the encrypted information is tow-dimensionally coded. It should be noted that, the two-dimensional code is assumed to be valid for several minutes.

A user provides a code outputted in S604 at the time of subsequent payment at a cash register (S604). The payment apparatus 20 reads the code and decrypts the code with a private key, thereby, acquiring the user ID, the information (AppID) for identifying the relay apparatus 30, the credit card information, and the available amount (credit data) (S606).

Next, the payment apparatus 20 transmits the user ID acquired in S606 to the relay apparatus 30 identified by AppID acquired in S606 (S607). The relay apparatus 30 generates a new payment ID and stores the payment ID in association with the user ID acquired in S606. Further, the relay apparatus 30 notifies the payment apparatus 20 of the newly generated payment ID (S608).

The payment apparatus 20 performs a process of registering a product to be paid for (S609). Specifically, product identification information of the product to be paid for is inputted to the payment apparatus 20. When acquiring the product identification information, the payment apparatus 20 acquires product information (selling price and so on) corresponding to the product identification information from a product master and registers the product information as a payment target.

Then, the payment apparatus 20 determines whether or not a payment amount is less than or equal to an available amount at the timing when the process of registering a product to be paid for is completed (for example: at the timing of pressing a “calculation start” button). In a case where the payment amount is less than or equal to the available amount, the payment apparatus 20 transmits a completion notification to the relay apparatus 30 (S609). The completion notification includes a payment ID. Meanwhile, in a case where the payment amount is not less than or equal to the available amount, the payment apparatus 20 shifts to, for example, a cash settlement mode.

The relay apparatus 30 transmits a user authentication request to the mobile terminal 10 by being triggered by the notification of S609 (S611). The mobile terminal 10 performs a user authentication process (FIDO) according to this (S612) and transmits a result to the relay apparatus 30 (S613). For example, the mobile terminal 10 accepts an input of biometric information and collates the inputted biometric information with the biometric information previously registered in the mobile terminal 10. Then, in a case where the collation is successful, the mobile terminal 10 digitally signs the information including the authentication result with the previously generated private key and transmits the information to the relay apparatus 30.

It should be noted that, in a normal FIDO protocol, the authentication request is kicked by transmitting a user identifier from a client to an authentication server. In contrast to this, in the example, the authentication request is kicked from the authentication server by using the user identifier stored in the authentication server (relay apparatus 30), which means a new logic different from the existing protocol. By doing so, it is possible to avoid transmission and reception of unnecessary information and to reduce a process time.

Thereafter, the relay apparatus 30 verifies validity of the authentication result received in S613 (S614). The verification is based on an authentication protocol of FIDO.

If there is no problem in the authentication result as a result of the verification, the relay apparatus 30 notifies the payment apparatus 20 that the user authentication is successful (S615). The payment apparatus 20 displays content to that effect on, for example, a display. It should be noted that, the payment apparatus 20 may output a receipt indicating payment details at this timing. Then, a user (customer) may be able to complete transaction at this timing and leave the store.

Thereafter, the payment apparatus 20 transmits payment information to the server 40 of a credit card company through the relay apparatus 30 (S617). Then, the server 40 makes settlement by a credit card based on the received information (S618). When the settlement is completed, the server 40 notifies the payment apparatus 20 to that effect through the relay apparatus 30 (S619).

Thereafter, the payment apparatus 20 performs a process of recording the payment information in sales (S619). Thereafter, the payment apparatus 20 transmits a payment ID and a settlement result to the relay apparatus 30 (S621). Then, the relay apparatus 30 registers the settlement result in the database (S622).

Hereinafter, an example of a reference model will be appended.

1. A program causing a computer of a mobile terminal to function as

an inquiry unit which transmits an inquiry on availability of a credit card to a relay apparatus and receives a response to the inquiry from the relay apparatus; and

an output unit which outputs card-related information including an available amount included in the response in a case where content of the response indicates the credit card being available.

2. The program described in 1, in which

the output unit outputs a code indicating the card-related information.

3. The program described in 1, in which

the output unit transmits the card-related information to a payment apparatus through a short-range wireless communication.

4. The program described in any one of 1 to 3, in which

the program causes the computer to

function as an authentication unit which performs a user authentication process according to a request from the relay apparatus.

5. The program described in 4, in which

the authentication unit accepts an input of biometric information, collates the biometric information with authentication information previously registered in the mobile terminal, and transmits a collation result to the relay apparatus.

6. The program described in any one of 1 to 5, in which

the card-related information includes a user ID (identifier) and information for identifying the relay apparatus.

7. The program described in any one of 1 to 6, in which

the response to the inquiry includes an expiration date of the response, and

the card-related information includes the expiration date of the response.

8. A mobile terminal including an inquiry unit which transmits an inquiry on availability of a credit card to a relay apparatus and receives a response to the inquiry from the relay apparatus, and

an output unit which outputs card-related information including an available amount included in the response in a case where content of the response indicates the credit card being available.

9. A method of controlling a mobile terminal performed by a computer of the mobile terminal, including

an inquiry step of transmitting an inquiry on availability of a credit card to a relay apparatus and receiving a response to the inquiry from the relay apparatus; and

an output step of outputting card-related information including an available amount included in the response in a case where content of the response indicates the credit card being available.

10. A payment apparatus including a card-related information acquisition unit which acquires card-related information including an available amount of a credit card by reading a code indicating the card-related information or by performing a short-range wireless communication with a mobile terminal in which the card-related information is stored,

a product information acquisition unit which acquires product identification information of one or a plurality of products to be paid for,

a determination unit which determines whether or not settlement by the credit card is possible based on the available amount and a payment amount calculated based on the product identification information,

an output unit which outputs a determination result of the determination unit, and

a payment unit which performs a payment process based on the determination result of the determination unit.

11. The payment apparatus described in 10, in which

the determination unit determines that the settlement by the credit card is possible in a case where the payment amount is less than or equal to the available amount.

12. The payment apparatus described in 10 or 11, in which

the determination unit determines whether or not the settlement by the credit card is possible each time the product information acquisition unit acquires new product identification information, based on the payment amount and the available amount at that time.

13. The payment apparatus described in any one of 10 to 12, in which

the card-related information includes a user ID and information for identifying the relay apparatus,

the payment apparatus further includes a user identification information transmission unit which transmits the user ID to the relay apparatus,

when receiving a notification that authentication of a user identified by the user ID is successful from the relay apparatus, the determination unit determines that the settlement by the credit card is possible.

14. The payment apparatus described in any one of 10 to 13, in which

the card-related information includes an expiration date, and

the determination unit determines that the settlement by the credit card is impossible in a case where the expiration date has passed.

15. The payment apparatus described in any one of 10 to 14, in which

the payment unit makes the settlement by the credit card in a case where the determination unit determines that the settlement by the credit card is possible.

16. The payment apparatus described in 15, in which

the payment unit

transmits a request for the settlement by the credit card to a server of a credit card company through the relay apparatus or without passing through the relay apparatus and receives a reply to the request during the settlement by the credit card, and

the output unit

outputs the determination result of the determination unit before reception of the reply to the request is completed.

17. The payment apparatus described in any one of 10 to 16, in which

the payment unit performs a payment process by a means other than the credit card in a case where the determination unit determines that the settlement by the credit card is impossible.

18. A payment method performed by a computer, including

a card-related information acquisition step of acquiring card-related information including an available amount of a credit card by reading a code indicating the card-related information or by performing a short-range wireless communication with a mobile terminal in which the card-related information is stored,

a product information acquisition step of acquiring product identification information of one or a plurality of products to be paid for,

a determination step of determining whether or not settlement by the credit card is possible based on the available amount and a payment amount calculated based on the product identification information,

an output step of outputting a determination result of the determination step, and

a payment step of performing a payment process based on the determination result of the determination step.

19. A program causing a computer to function as

a card-related information acquisition unit which acquires card-related information including an available amount of a credit card by reading a code indicating the card-related information or by performing a short-range wireless communication with a mobile terminal in which the card-related information is stored,

a product information acquisition unit which acquires product identification information of one or a plurality of products to be paid for,

a determination unit which determines whether or not settlement by the credit card is possible based on the available amount and a payment amount calculated based on the product identification information,

an output unit which outputs a determination result of the determination unit, and

a payment unit which performs a payment process based on the determination result of the determination unit.

20. A relay apparatus including a relay unit which transmits an inquiry on availability of a credit card to a server of a credit card company when receiving the inquiry on the availability of the credit card from a mobile terminal, and transmits a response to the mobile terminal when the response to the inquiry is received from the server.

21. The relay apparatus described in 20, in which

the relay unit receives an available amount from the server and transmits the available amount to the mobile terminal.

22. The relay apparatus described in 20 or 21, further including

an authentication relay unit which transmits a user authentication request to the mobile terminal and then transmits a result of user authentication to a payment apparatus.

23. A relay method performed by a computer, including

a relay step of transmitting an inquiry on availability of a credit card to a server of a credit card company when receiving the inquiry on the availability of the credit card from a mobile terminal, and transmitting a response to the mobile terminal when the response to the inquiry is received from the server.

24. A program causing a computer to function as

a relay unit which transmits an inquiry on availability of a credit card to a server of a credit card company when receiving the inquiry on the availability of the credit card from a mobile terminal, and transmits a response to the mobile terminal when the response to the inquiry is received from the server.

25. A payment system including the payment apparatus described in any one of 10 to 17, and the relay apparatus described in any one of 20 to 22.

This application claims priority on the basis of Japanese Patent Application No. 2018-148746 filed on Aug. 7, 2018, and entirety of the disclosures is incorporated herein.

What is claimed is:

1. A non-transitory storage medium storing a program causing a computer of a mobile terminal to:
transmit an inquiry on availability of a credit card to a relay apparatus and receive a response to the inquiry from the relay apparatus; and
output card-related information including an available amount included in the response in a case where content of the response indicates the credit card being available.

2. The non-transitory storage medium storing the program according to claim 1,
wherein the program causes the computer to output a code indicating the card-related information.

3. The non-transitory storage medium storing the program according to claim 1,
wherein the program causes the computer to transmit the card-related information to a payment apparatus through a short-range wireless communication.

4. The non-transitory storage medium storing the program according to claim 1,
wherein the program causes the computer to perform a user authentication process according to a request from the relay apparatus.

5. The non-transitory storage medium storing the program according to claim 4,
wherein the program causes the computer to accept an input of biometric information, collate the biometric information with authentication information previously registered in the mobile terminal, and transmit a collation result to the relay apparatus.

6. The non-transitory storage medium storing the program according to claim 1,
wherein the card-related information includes a user ID (identifier) and information for identifying the relay apparatus.

7. The non-transitory storage medium storing the program according to claim 1, wherein
the response to the inquiry includes an expiration date of the response, and
the card-related information includes the expiration date of the response.

8-9. (canceled)

10. A payment apparatus comprising:
at least one memory configured to store one or more instructions; and
at least one processor configured to execute the one or more instructions to:
acquire card-related information including an available amount of a credit card by reading a code indicating the card-related information or by performing a short-range wireless communication with a mobile terminal in which the card-related information is stored;
acquire product identification information of one or a plurality of products to be paid for;
determine whether or not settlement by the credit card is possible based on the available amount and a payment amount calculated based on the product identification information;
output a determination result about whether or not settlement by the credit card is possible; and
perform a payment process based on the determination result.

11. The payment apparatus according to claim 10,
wherein the processor is further configured to execute the one or more instructions to determine that the settlement by the credit card is possible in a case where the payment amount is less than or equal to the available amount.

12. The payment apparatus according to claim 10,
wherein the processor is further configured to execute the one or more instructions to determine whether or not the settlement by the credit card is possible each time new product identification information is acquired, based on the payment amount and the available amount at that time.

13. The payment apparatus according to claim 10,
wherein the card-related information includes a user ID and information for identifying the relay apparatus,
wherein the processor is further configured to execute the one or more instructions to:
transmit the user ID to the relay apparatus, and
when receiving a notification that authentication of a user identified by the user ID is successful from the relay apparatus, determine that the settlement by the credit card is possible.

14. The payment apparatus according to claim 10,
wherein the card-related information includes an expiration date, and
wherein the processor is further configured to execute the one or more instructions to determine that the settlement by the credit card is impossible in a case where the expiration date has passed.

15. The payment apparatus according to claim 10,
wherein the processor is further configured to execute the one or more instructions to make the settlement by the credit card in a case where the processor determines that the settlement by the credit card is possible.

16. The payment apparatus according to claim 15,
wherein the processor is further configured to execute the one or more instructions to:
transmit a request for the settlement by the credit card to a server of a credit card company through the relay apparatus or without passing through the relay apparatus and receive a reply to the request during the settlement by the credit card, and
output the determination result before reception of the reply to the request is completed.

17. The payment apparatus according to claim 10,
wherein the processor is further configured to execute the one or more instructions to perform a payment process by a means other than the credit card in a case where the processor determines that the settlement by the credit card is impossible.

18-25. (canceled)
